(19) United States
(12) Patent Application Publication
(10) Pub. No.: US 2015/0112770 A1
(43) Pub. Date: Apr. 23, 2015

(54) METHOD FOR EVALUATING AND MANAGING PROJECT PERFORMANCE USING COMMUNICATION

(71) Applicant: Mark Phillips, West Bloomfield, MI (US)

(72) Inventor: Mark Phillips, West Bloomfield, MI (US)

(21) Appl. No.: 14/058,674

(22) Filed: Oct. 21, 2013

(51) Int. Cl. G06Q 10/06

(52) U.S. Cl. CPC G06Q 10/0639
USPC 705/7.38

(57) ABSTRACT

A method of improving project outcome by using communication to assess a project, and improving the project outcome. A method of evaluating project performance based on the communication environment and communication objects used by identifying the desired characteristics of the project, selecting characterizations of the communication environment and communication objects to be Measurable Communication Actions (MCAs), establishing a baseline of planned communication (P COM) expressed in terms of the MCAs, taking measurements throughout the course of the project to assess the actual values for the MCAs and obtaining Actual Communication (A COM), comparing the A COM against the P COM and deriving a communication variance (COM V), and tracking COM V against the desired characteristics of the project. Methods of evaluating training programs and communications with jurors, evaluating and improving leadership development programs, acquisition programs research, development and technology evaluation programs, and knowledge creation, knowledge discovery and knowledge sharing programs.

### BACKGROUND OF THE INVENTION

1. Technical Field

The present invention relates to methods of project management. More specifically, the present invention relates to methods of assessing and managing the performance of a project in terms of the communication environment and communication objects used.

2. Background Art

Communication is the way in which people interact on a project and answers the question as to why specific factors contribute to project characteristics. Communication, as well as the design of communication, is critical to the success of a project. It is estimated that a well performing manager spends upwards of 90% of their time on communication or communication related issues. Studies have shown that communication determines project outcomes (Conway 1968, MacCormack, et al. Harvard Business School Work Paper 08-039 2008). When communication is ineffective, projects fail or exhibit undesired characteristics such as being over budget. As an example, the 2013 Report on the Performance of the U.S. Defense Acquisition System found that ineffective communication, in the form of poor situational awareness of what was going on in a project, and in the form of poorly translating requirements into testable specifications, was a dominant root cause of cost growth in over 50% of major defense acquisition programs that had shown significant cost growth. This has cost the U.S. taxpayers billions of dollars in cost overruns. The U.S. Department of Defense has identified communication as the solution to these longstanding problems (U.S. DOD, “PARCA: The Next Generation of Earned Value Management 2013”, Measurable News Issue 4 2013), however, there currently are not effective evaluation methods to adequately determine how to evaluate or improve communication. This leaves a gap in the ability to evaluate and improve the root cause of project performance.

Current performance evaluation methods focus on outcomes. This includes evaluating performance based on items such as task completion, schedule performance, budget performance, technical performance, comparison against requirements, profitability, Return on Investment (ROI), impact on market position, or whether the project attained the desired results. Performance evaluation methods can focus on one outcome or, as in the case of Earned Value Management (EVM), can integrate several outcome measures into one integrated management tool. However, these performance evaluation methods focus on what has happened rather than why it has happened. To paraphrase the 2013 Report on the Performance of the U.S. Defense Acquisition System, the current performance evaluation tools have limitations since they do not explain the underlying reasons why some factors contribute to undesired project characteristics such as cost growth or poor schedule performance.

In light of the foregoing, there is a pressing and longstanding need for performance evaluation methods that explicitly identify, monitor and track key framing assumptions, communication effectiveness, and communication designs that leads to undesired project characteristics such as cost overruns. In addition, to quote the 2013 Report on the Performance of the U.S. Defense Acquisition System, such a program evaluation method “should enable earlier detection and adjustment for problems that lead to poor cost, schedule, and technical performance.” Additionally, there is a pressing and longstanding need for a performance evaluation method that address the underlying reasons as to why projects exhibit the characteristics they do, whether desired or undesired characteristics.

Previously used methods of project performance evaluation have not been able to successfully uncover areas where improvements or managerial actions can be implemented to the communication environment and communication objects. These efforts must have currency and must be adequately monitored and tracked over time. Therefore, there is a need for a process for effectively evaluating the performance of project relative to the communication environment and the communication objects.

The example from the Defense industry is only one example of the need. Other industries, governments, and organizations which operate in competitive environments or which deliver projects have a longstanding need for improved performance evaluation to better assure project success and reduce undesirable project characteristics such as cost overruns, poor schedule performance and poor technical performance.

### SUMMARY OF THE INVENTION

The present invention provides for a method of improving project outcomes by using communication to assess a project, and improving the project outcomes.

The present invention provides for a method of evaluating project performance based on the communication environment and communication objects used by identifying the desired characteristics of the project, selecting characterizations of the communication environment and communication objects to be Measurable Communication Actions (MCAs), establishing a baseline of planned communication (P COM) expressed in terms of the MCAs, taking measurements throughout the course of the project to assess the actual values for the MCAs and obtaining Actual Communication (A COM), comparing the A COM against the P COM and deriving a communication variance (COM V), and analyzing and tracking COM V against the desired characteristics of the project.

The present invention provides for a method of evaluating training programs, by identifying the desired goals of the communications, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and taking action to improve training programs based on an analysis of the COM V.

The present invention provides for a method of evaluating communications with jurors, by identifying the desired characteristics of the communications, selecting characterizations of the communication environment and communication objects to be Measurable Communication Actions (MCAs), establishing a baseline of planned communication (P COM), taking measurements throughout the course of the project to assess actual values for the MCAs and obtaining Actual Communication (A COM), comparing the A COM against the P COM and deriving a communication variance (COM V), and modifying statements during a trial based on an analysis of the COM V.

The present invention provides for a method of evaluating and improving leadership development programs, by identifying the desired characteristics of the programs, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and modifying communications based on an analysis of the COM V.

The present invention provides for a method of evaluating and improving acquisition programs, by identifying the desired characteristics of the programs, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and modifying communications based on an analysis of the COM V.

The present invention provides for a method of evaluating and improving research, development and technology evaluation programs, by identifying the desired characteristics of the programs, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and modifying communications based on an analysis of the COM V.

The present invention provides for a method of evaluating and improving knowledge creation, knowledge discovery and knowledge sharing programs, by identifying the desired characteristics of the programs, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and modifying communications based on an analysis of the COM V.

### DESCRIPTION OF THE DRAWINGS

Other advantages of the present invention are readily appreciated as the same becomes better understood by reference to the following detailed description when considered in connection with the accompanying drawings wherein:

FIG. 1 is a chart of selected Planned Communication with characteristics to be desired in a sample project;

FIGS. 2A and 2B are graphs showing P COM and A COM for scenarios two and three, respectively;

FIG. 3 is a depiction of an email inbox;

FIGS. 4A and 4B are depictions of the texts of emails;

FIG. 5 is a depiction of an email inbox;

FIG. 6 is a depiction of the texts of emails;

FIG. 7 is a depiction of the texts of emails;

FIG. 8 is a depiction of the texts of emails;

FIG. 9 is a graph of the number of emails and known issues over time;

FIG. 10 is a graph of the open rate of emails over time; and

FIG. 11 is a graph of reply rates to emails over time.

### DETAILED DESCRIPTION OF THE INVENTION

This invention provides for a method for effectively evaluating and managing the performance of a project, program, organizational initiative or management effort (hereinafter “project”). The method improves project results by using communication criteria within and about the project environment. Therefore, most generally, the present invention provides for a method of using communication to assess a project, and improving the project outcome. More specifically, the method includes establishing a baseline of planned communication decisions, measuring actual communication, calculating a variance in communication, and using the variance to modify future planned communication decisions.

Planned Communication (P COM), as used herein, is the amount of communication planned, or scheduled, to take place in a particular period of time. It is expressed in the unit of measurement of the communication.

Actual Communication (A COM), as used herein, is the actual amount of communication that took place in a particular period of time. It is expressed in the unit of measurement of the communication.

Communication Variance (COM V), as used herein, is the variance between actual communication and planned communication for a particular period of time. It is A COM−P COM. It is expressed in the unit of measurement of the communication.

A Measurable Communication Action (MCA), as used herein, is a single unit of measurement of communication in an environment. It provides a means to measure and integrate multiple communication methods, communication elements, and design decisions into a single unit of measurement. It can be made up of a single method of communication or multiple methods of communication. The methods can be added together, giving all methods equal weight. Alternatively, different methods can be weighted when combining them into an MCA. The weighting can reflect variables such as the relative value management places on each form of communication or the strictness with which communication design decisions are enforced for each method of communication. It can reflect the phase of the project or the expected activities for that period of time. It can be tweaked to increase sensitivity towards one method of communication over another to facilitate management awareness of unpredicted behavior.

Communication is herein disaggregated into the communication environment and communication objects. The disaggregation categorizes communication into discreet components to which analytic processes and tools can be applied. This facilitates the ability to characterize communication into measurable factors (MCAs) that can be tracked and modified over the course of the project, or across repeated projects.

The communication environment, as used herein, is the structure of an environment as it relates to communication. It determines the communication generated in an environment. The communication environment is structured by decisions made about the project environment and by constraints existing around the project environment. These decisions and constraints are called elements of the communication environment. Examples include, but are not limited to, the communication tools or methods used in an environment (email, phone, social media, chat, faxes), rules or guidelines on using communication tools or methods, how task assignments are made, how teams are organized, where personnel are located, the amount of oversight required, rules and guidelines on project governance, how tasks are described, when communication takes place, what types of documents are generated (.doc, .pdf), and who can talk to whom on a project.

Communication objects, as used herein, are the artifacts generated by the process of communication. A communication object is more than the information it is meant to contain. It is made up of numerous elements, including descriptors of the container itself, much like how an in-person conversation between two people is made up of non-verbal elements as well as the words in the conversation. Communication objects encompass the “non-verbal” elements of communication. Examples of the communication objects include, but are not limited to, work breakdown structures (WBS), the WBS dictionary, Integrated Master Plans (IMP), the organizational breakdown structure (OBS), emails, phone calls, phone messages, reports, chat messages, texts, attachments in emails, documents (such as pdfs, word processing documents), message board posts, meeting notes, meetings, risk registers, responsibility assignment matrices, a project schedule, a project budget, compliance regulations, compliance filings, regulatory filings, guidelines, phone conversations, entries in a calendar, and memos. Communication objects can be anything that can be written down, recorded, observed, or fixed in some manner.

Communication object elements are the observable elements of communication objects. Communication object elements and communication environment elements allow for the characterization of a communication environment. The characterization of the communication environment or communication objects can be counting emails or counting the number of meetings that take place according to meeting notes. Further characterizations are created through applying other analytic methods to the communication environment or communication objects. Examples of characterizations, and characterization rules, for inclusion as an MCA include, the format information is in (e.g. graphically represented or represented in a table), semantic analysis (e.g. reading grade level of the words used, the number of words, the number of words that are repeated, clusters of words, clusters of topics, word clouds, theme clouds, the number of passive sentences, an analysis of how similar the words in the document are to the words used in other documents), social network analysis, LIWC analysis (e.g. the degree any text uses positive or negative emotions, self-references, causal words and other language dimensions), number of communications sent (i.e. number of emails, texts, phone calls), number of communications sent within an environment (i.e. how many emails does that environment generate per day), use as a boundary object, assessments of cultural characteristics, relationship of the sender and receiver, whether an attachment in an email is opened, whether an email is replied to, similarity of the format of documents that a sender and receiver send in emails, who is copied on a message (cc and bcc) and others. In other words, measurable aspects of the communication objects and the communication environment become the MCA.

More specifically, the present invention provides for a method of evaluating project performance based on the communication environment and communication objects used by identifying the desired characteristics of the project, selecting characterizations of the communication environment and communication objects to be Measurable Communication Actions (MCAs), establishing a baseline of planned communication (P COM) expressed in terms of the MCAs, taking measurements throughout the course of the project to assess the actual values for the MCAs and obtaining Actual Communication (A COM), comparing the A COM against the P COM and deriving a communication variance (COM V), and analyzing COM V and tracking COM V against the desired characteristics of the project.

The desired characteristics are identified that are particular to the project being evaluated as are the desired outcome or performance of the project, e.g. being on budget or delivering a product.

The selected characterizations are the result of applying an analytic tool or process to the communication environment or communication objects such as counting the number of emails, conducting semantic analysis on a report, conducting social network analysis of the people on a conference call, or a quantification or analysis of any of the other characteristics described above. In other words, the selected characterizations are the communication object elements and communication environment elements. The selected characterizations are termed Measurable Communication Actions (MCAs) as described above and form the unit of measurement for performance evaluation.

A baseline is established by setting the expected number of MCAs for a period of time. This is the P COM. Each period of time can have a different value for the MCAs, as it is particular to a specific time period. For example, one week can have a particular P COM value, while another week has a different value. The period of time can be any appropriate period of time for the particular project, and can be, but is not limited to, hours, days, weeks, months, years, and combinations thereof. The period of time can also be dependent on other activities such as the phase of a project. For example, the period of time can be the amount of time it takes to complete the requirements gathering phase of a project.

Measurements are taken throughout the project to obtain the A COMs. Measurements can be taken at any appropriate time, such as, but not limited to, real-time, semi-real-time, every hour, every day, every week, every month, every year, and combinations thereof. Measurements can also be taken every time a communication action or event occurs, and can be triggered by an action or event. Also, the time that a measurement is taken does not have to be predetermined.

The variance (COM V) is used to evaluate the performance of the project. By comparing the COM V with the desired characteristics of the project, those in charge of the project can make a decision to change the communication environment or communication objects, by changing the design of the environment, the design of the objects, or by changing elements of the environment or elements of the objects or institute any other necessary changes in the way the project is handled. Forward-looking P COM values can be changed based on COM V results, i.e. the planned or expected communication can be changed for a future period of time. Based on how often the A COMs are measured, the COM V can be derived in real-time or near real-time. This allows for changes to forward-looking P COM values and any communication object elements and communication environment elements in both number and type in real-time as well and failures can be avoided. Changes can then be made in the communication environment and communication objects used in the project environment to manage the performance of the project. The result of the method is that communication, as well as the design of the communication environment and communication objects, within a project should be an intentional action that moves the project towards completion and/or towards the desired goals.

The method can be performed multiple times over the course of a project. In other words, at any particular point after A COMs have been obtained, the COM V can be derived and the communication in the project can be evaluated to determine if changes need to be made.

Throughout the project, communication decisions and rules can be enforced, suggested, or auto-corrected. Software and any necessary applications can be used to perform the enforcement, suggestions, or auto-correction. For example, if it has been decided that emails should not be more than 200 characters in length for a project, typing after 200 characters can be blocked (enforcement), or a warning can pop-up that emails should be 200 characters or less when typing more than 200 characters (suggestion). An example of auto-correction is if a project requires a certain person copied on all emails, and that person is left off of an email, before the email is sent, the required person's email address is added by software to the email.

The method can further include a step of alerting a project manager or other individual that the project is headed towards or has the potential for undesired results or failure. Because the method can uncover problems ahead of time because communication reflects and determines human behavior and decision making and can optionally provide real-time analysis of all of the selected communications on a project, at any point that the COM V is at an undesired level or value as defined by the users of the method, an alert can be made to make changes to the communication decisions used in the project in order to fix any problems. For example, communication decisions can be changed in response to the alert. The alert can be in the form of an email, text message, phone message, visual alert, noise, reported value in a report, combinations thereof, or any other appropriate alert, or way of flagging COM V outside a desired threshold range.

The method can further include the step of creating communication guidelines. Based on results obtained with the method, businesses can develop communication guidelines and rules for projects that should be followed, either at all times, or in certain applicable circumstances. Essentially, the communication guidelines become the “best practices” for the business.

The method can be applied throughout the lifecycle of a single project. It can also be applied across numerous projects.

The method of the present invention can also be combined with existing methods such as Earned Value Management (EVM) to evaluate the effect of communication decisions on schedule, cost, and technical performance. The method can be combined with measures such as profitability, number of innovations, number of patents, market position, riskiness, number of participants, contribution of participants, outcome at a trial, trust within a group, knowledge sharing, knowledge creation, knowledge development, leadership ability, proficiency in a desired competency or competencies, technical readiness level, fitness for a specific purpose, marketability, revenue, cost to produce innovation, cost to deliver desired capabilities, the amount of time it takes to deliver desired capabilities, return on investment, return on capital, stock market performance, combinations thereof, or other outcome measures.

The performance evaluation method can include software, or analytic processes to calculate the various communications, characteristics, or variances. An analytic process can be conducted manually or with the aid of software programs. The software can be a standalone application or one which integrates with other software systems or processes. For example, the software can be an application (i.e. app) that plugs into an existing platform that works with email, messaging, and document (word processing, spreadsheets, presentations) editing and creation software programs, such as, but not limited to, MICROSOFT® EXCHANGE SERVER®, MICROSOFT® OUTLOOK®, GMAIL© (Google) Google DRIVE©, or MICROSOFT® OFFICE. The software can integrate or be combined with other tools or analytic processes that create the elements, i.e. that create the characterizations, such as, but not limited to, the Fesh Kincaid grade level in MICROSOFT® OFFICE. For example, the software can be tied into email, accounting, and project management software to see the grade level of reports that are sent out using outlook and compare it against performance of the project.

Thus, for example, an integrated tool set can be created. The integrated tool set can include the objects to be analyzed, the analytic process or processes that generate the object elements, and a measure or measures of the desired project characteristics, such as the project's budget performance. The tool set can then allow for the development of the P COM, A COM, and COM V and an analysis of these items against the project's performance relative to desired project characteristics. For example, it can track budget performance against the expected versus actual number of emails sent in a particular period of time. Management actions can then be taken to optimize or improve the number of emails needed to obtain the desired budget performance of the project. Further examples include integrating other variables. For example, instead of measuring and making decisions on the number of emails, the communication element utilized for performance management could be the length of the emails. Or, it could be based on an analysis of the attachment to emails looking at how often the attachment is opened by the recipient, integrated with an analysis of the coincidence of words in the attachment to the sender's files compared to the receiver's files. The integrated metric is then compared against the budget performance of the project. It has always been said that effective communication depends on how the communication is received (beauty is in the eye of the receiver). This allows you to track that, measure it, change it and see how it impacts project performance.

The following is a further description of how an integrated tool set would work using the method. Any suitable software products and tools can be used that perform the required functions.

A project plan can be created in project management software programs. An individual can communicate out with people who are part of the project using an integrated communication module. This communication can be done using various objects such as sending a message. Communication can also be done using an email program with objects such as attachments that are created in a word processing program. Communication can also take place using software that provides features for voice communication, video communication and instant messaging. Communication object elements can be generated by applying an analytic tool or process to the objects. For example, word count can be analyzed of an attachment made in the word processing program that is sent out to people on the project via the email program. Many other aspects of any of the objects can be analyzed such as looking for a particular format of tables in a spreadsheet, or set of words in a voice communication, and comparing that back to project performance.

One characterization, one communication design decision or guideline, can be that all reports have to be in a document and created by a particular word processing program and contain no more than 1,000 words. There can be an expected number of MCA's for a particular phase of a project (P COM). As the project progresses, the actual number of MCA's is tracked (A COM) and compared against P COM to create a Communication Variance (COM V). This value of COM V can be compared against how the project is performing based on data from the project management software. Management can then alter the communication design decisions accordingly to change the word count of documents to improve the performance of the project.

Reports about COM V and project performance can be created as part of the tool set. As well, key performance indicators (KPI's) and best practice guidelines of specific COM V values, MCA characterizations, communication design decisions, P COM and A COM values can all be part of a tool set.

The communication design decision guidelines or rules can be built into the word processing program. For example, the word processing program can flag a user that they are above the communication guideline when they run a “spelling and grammar” type review of the document created with the word processing program. This would be a “performance evaluation” type review of the document. The same process could be done when analyzing the WBS structure of a project plan or the effect of various graphical representations of project information on the performance of the project.

The performance evaluation method can be stored on a computer readable medium in machine code or embedded software. The project participants can obtain A COM and P COM values, the values can be sent to a central server, the analysis with the V COM can be performed centrally on a server, and then the results can be sent to the project participants. A website can be used to enter all the required information and can perform the analysis of the method. Alternatively, a handheld tablet, mobile computing device, or cloud can be preprogrammed with any necessary software to perform the method and an individual can enter in required information. The software on the handheld tablet, mobile computing device, or cloud can analyze the information or the information can be sent to a server that performs the analysis. Any electronic communication between software and servers or handheld devices can be wireless or wired.

The performance evaluation method can be used to create an assessment tool to assess the fitness of a communication environment or communication objects for meeting specific project outcomes or for a project to display specific characteristics. Such an assessment tool can also be used to determine development actions or exercises to improve competencies within a project or modify the environment's fitness for a particular desired set of outcomes or project characteristics. The assessment tool can be a maturity model that assesses communication and provides certification of communication. Businesses can then be certified for a certain level of communication. Based on communication maturity, businesses and organizations can be awarded projects based on their certification at a certain level of communication.

The performance evaluation method can be used in various situations besides business. For example, communications within a training program can be analyzed in order to improve the training methods. Therefore, the present invention provides for a method of evaluating training methods, by identifying the desired characteristics of the communications, selecting characterizations of the communication environment and communication objects to be Measurable Communication Actions (MCAs), establishing a baseline of planned communication (P COM), taking measurements throughout the course of the project to assess actual values for the MCAs and obtaining Actual Communication (A COM), comparing the A COM against the P COM and deriving a communication variance (COM V), and taking action to improve training programs based on an analysis of the COM V. Each of these steps can be performed as described above.

Transcripts of trials and other observable elements of a trial can also be used to analyze which particular phrases have an effect with jurors. Based on the analysis, the prosecutors or defense attorneys can modify what statements they use to have the desired effect on the jurors. Therefore, the present invention provides for a method of evaluating communications with jurors, by identifying the desired characteristics of the communications, selecting characterizations of the communication environment and communication objects to be Measurable Communication Actions (MCAs), establishing a baseline of planned communication (P COM), taking measurements throughout the course of the project to assess actual values for the MCAs and obtaining Actual Communication (A COM), comparing the A COM against the P COM and deriving a communication variance (COM V), and modifying statements during a trial based on an analysis of the COM V.

Leadership development programs can be evaluated and improved, by identifying the desired characteristics of the programs, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and modifying communications based on an analysis of the COM V.

Acquisition programs can be evaluated and improved, by identifying the desired characteristics of the programs, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and modifying communications based on an analysis of the COM V.

Research, development and technology evaluation programs can be evaluated and improved, by identifying the desired characteristics of the programs, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and modifying communications based on an analysis of the COM V.

Knowledge creation, knowledge discovery, and knowledge sharing programs can be evaluated and improved, by identifying the desired characteristics of the programs, selecting characterizations of the communication environment and communication objects to be Measurable Communication Actions (MCAs), establishing a baseline of planned communication (P COM), taking measurements throughout the course of the program to assess actual values for the MCAs and obtaining Actual Communication (A COM), comparing the A COM against the P COM and deriving a communication variance (COM V), and modifying communications based on an analysis of the COM V.

The performance evaluation method improves over previous methods because it provides a real-time analysis tool of how a project is working instead of an evaluation based on outcomes that are focused after the fact on results. In the present invention, one can determine how a project is working and then based on the real-time results, the communication decisions within the project can be altered to fix any problems that arise along the way rather than identifying the problems after the project has finished. Alternatively, individuals can work within the environment, in the case where aspects of the project cannot be changed. At least knowing how the project and people are being affected by communication decisions which cannot be changed allows individuals to manage within those constraints. Individuals can see how communication decisions are impacting people and work within that rather than being blind to what is really going on (i.e. blind to the impact communication is having on the project).

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teaching provided herein. The examples can also be found in Phillips, Mark. Reinventing Communication: How to Design, Lead and Manage High Performing Projects. Gower Press, 2014.

### Example 1

TABLE 1 describes the approach for using communication as a performance management tool. It describes the technique using three different dimensions of description: Conceptual, Tactical and Measurable. Conceptual describes the general concept of the process. Tactical describes the tactics to turn the concept into action. Measurable describes the tactical in terms of a measurable metric that can be analyzed and improved.

TABLE 1

| Conceptual | Tactical | Measurable |
|---|---|---|
| Step 1: | a. Identify the elements of | i. Analyze the project |
| Understand the | communication design in the | environment to identify the |
| communication environment | environment | elements of communication |
| of the project environment | | design. |
| | | ii. Translate those elements |
| | | into measurable |
| | | observations. |
| | b. Identify the elements of | i. Apply analytic tools to |
| | communication objects in | communication objects to |
| | the environment | derive communication object |
| | | elements. |
| | | ii. Translate those elements |
| | | into measurable |
| | | observations. |
| Step 2: | a. Identify current solution | i. Analyze the project |
| Understand the observable | delivery capabilities. | environment to identify the |
| behaviors of the project | | current solution delivery |
| environment | | capabilities. |
| | | ii. Translate those |
| | | capabilities into measurable |
| | | observations. |
| | b. Identify current outcomes | i. Analyze the project |
| | of the project environment. | environment to identify the |
| | | current outcomes produced |
| | | by the project environment. |
| | | ii. Translate those outcomes |
| | | into measurable |
| | | observations. |
| Step 3: | a. Identify the relationship | i. Utilize measurable |
| Understand the relationship | between elements of | observations over time |
| between the communication | communication design and | |
| environment and the | observable behaviors of the | |
| observable behaviors of the | project environment. | |
| project environment. | b. Identify the relationship | i. Utilize measurable |
| | between elements of | observations over time. |
| | communication objects and | |
| | observable behaviors of the | |
| | project | |
| Step 4: | a. Identify desired solution | i. Identify the desired |
| Identify desired observable | delivery capabilities. | solution delivery capabilities. |
| behaviors for the project | | ii. Translate those desired |
| environment. These are the | | capabilities into measurable |
| performance goals. | | observations. This is what |
| | | attaining the performance |
| | | goal looks like, expressed in |
| | | terms of the measurable |
| | | observation which |
| | | corresponds to the desired |
| | | solution delivery capability. |
| | b. Identify desired outcomes. | i. Identify the desired |
| | | outcomes for your project |
| | | environment. |
| | | ii. Translate those desired |
| | | outcomes into measurable |
| | | observations. This is what |
| | | attaining the performance |
| | | goal looks like, expressed in |
| | | terms of the measurable |
| | | observation which |
| | | corresponds to the desired |
| | | solution delivery capability. |
| Step 5: | a. Select elements based on | i. Which elements can help |
| Select communication | the understanding from Step | achieve desired solution |
| elements to use to achieve | 3. | delivery capabilities. |
| desired project behaviors in | | ii. Which elements can help |
| the project environment. | | achieve desired outcomes. |
| | b. Select elements based on | i. Which elements can help |
| | what can be measured, | achieve desired solution |
| | monitored and changed. | delivery capabilities. |
| | Understand the span of | ii. Which elements can help |
| | control and focus on those | achieve desired outcomes. |
| | elements you can impact. | |
| | c. Select elements based on | i. Which elements can help |
| | additional analysis and | achieve desired solution |
| | understanding. | delivery capabilities. |
| | | ii. Which elements can help |
| | | achieve desired outcomes. |
| Step 6: | a. Design, plan, execute, control and manage project | |
| Use the selected elements | environments using those elements. | |
| to achieve the desired | b. Generate data on the selected communication elements | |
| project behaviors for the | and achievement of the desired project behaviors. | |
| project environment. | c. Interpret the data and | i. This can require changing |
| | make changes to elements | the project environment. |
| | to steer towards desired | ii. This can require managing |
| | project behaviors. | specific people or changing |
| | | elements to work with |
| | | specific people and groups. |

d. Iterate the process to help achieve the target observable
behavior and desired outcomes.

TABLE 1 can be read both down one dimension and, down and across the different dimensions. Reading TABLE 1 down provides a description of the technique in three different ways. Reading TABLE 1 down and across provides a description of the technique and a flow of how the technique can be implemented into a specific set of metrics. Steps 1 through 3 entail understanding the environment. Step 4 entails setting a goal and expressing the goal in terms of communication. Step 5 entails selecting which communication variables to use to achieve the desired goal. Step 6 entails execution and this is where the communication variables selected in Step 5 are utilized to achieve the goals set in Step 4. Step 6 includes iterative cycles of evaluating the results, making modifications and honing in on the goal.

### Example 2

TABLE 2 describes the development and use of a specific application of the formal method. It links communication and project performance. It can be used to develop the embodiment discussed below and it provides guidance on how to manage project performance using that type of metric. Areas of further expansion on the technique is provided in parenthesis in the checklist and prefaced with the word “Extension.” The extensions also provide a deeper window into the theoretical assumptions behind the technique and they discuss areas where the technique can be tailored and expanded.

TABLE 2

| 1. | Develop an integrated communication strategy as a baseline of | |
|---|---|---|
| | planned communication in the project environment | |
| | a. | Define the unit of measurement for communication. This is |
| | | generally the y axis of a graph of performance management. |
| | | In the example below we used number of emails. The unit of |
| | | measurement can be generalized into a Measurable |
| | | Communication Action (MCA). |

| | |
|---|---|
| i. | Is that unit of measurement valid given the |
| | communication methods used in the project |
| | environment and other communication design |
| | decisions? |
| ii. | Is that unit of measurement an accurate reflection of |
| | the target observable behavior you want to for your |
| | project environment? |

| | |
|---|---|
| b. | Define a relevant corresponding variable to track against the |
| | unit of measurement for communication. This is generally the |
| | x axis of a graph of performance management. In the |
| | example above we used time. We did this since we were |
| | tracking the relationship between the schedule performance |
| | of tasks over time and communication over time. |
| | (Extension: This can be generalized to other variables |
| | depending on the integrated communication strategy and |
| | hypothesis of communication which you are tracking. For |
| | example, this could be phases of a project in which case you |
| | track planned communication against the phase of a project |
| | such as how much effective communication is there during |
| | the initiation phase of a project, the requirements gathering |
| | phase, the execution phase, etc. Or, you could track against |
| | the stages of team formation such as planned communication |
| | when the team is forming, storming, norming, etc. ) |

| | |
|---|---|
| i. | Is that unit of measurement valid given the |
| | communication methods used in the project |
| | environment and other communication design |
| | decisions? |
| ii. | Is that unit of measurement an accurate reflection of |
| | the target observable behavior you want for your |
| | project environment? |

| 2. | Develop an integrated baseline strategy for the planned target | |
|---|---|---|
| | observable behavior and desired outcome you want for the project | |
| | environment. | |
| | a. | Define the unit of measurement for the target observable |
| | | behavior and outcome. This is generally the y axis of a graph |
| | | of performance management. In the example below we use |
| | | task completion. (Extension: Task completion is dollarized |
| | | in an EVM system to derive a dollarized value of planned |
| | | tasks and compare that against the dollarized value of actual |
| | | tasks and the actual cost of planned tasks.) |

| | |
|---|---|
| i. | Is that unit of measurement valid given the tracking |
| | systems in place in the project environment? |
| ii. | Is that unit of measurement an accurate reflection of |
| | the target observable behavior you want to for your |
| | project environment? |

| | |
|---|---|
| b. | Define a relevant corresponding variable to track against the |
| | unit of measurement for target observable behavior and |
| | outcome. This is generally the x axis of a graph of |
| | performance management. This should be the same x axis |
| | variable as the one defined for tracking communication. |
| | (Extension: Using the same x axis variable, as it were, |
| | allows us to overlay communication measurement against a |
| | target behavior or outcome metric and establish a hypothesis |
| | of the relationship between communication, on the one hand, |
| | and performance of the project environment relative to the |
| | target behavior or outcome metric, on the other. In the |
| | example below time is used since the relationship between |
| | the schedule performance of tasks over time and |
| | communication over time was being tracked. The hypothesis |
| | was that communication is directly connected to task |
| | completion over time. And that communication, as defined by |
| | the integrated communication strategy, described how people |
| | should communicate in order to complete the tasks. This can |
| | be generalized to other variables depending on the target |
| | observable behavior or desired outcome and hypothesis of |
| | communication which are being tracking. For example, this |
| | can be phases of a project in which case planned |
| | communication is tracked against the phase of a project. The |
| | hypothesis would be that communication is directly |
| | connected to the phase of a project. And that communication, |
| | as defined by the integrated communication strategy, |
| | describes how people should communicate in each phase of |
| | the project. For further study, this can be linked together with |
| | other metrics such as schedule performance or cost |
| | performance to see how planned communication changes the |
| | schedule or cost performance of each phase.) |

| | |
|---|---|
| i. | Is that unit of measurement the same as the one used |
| | for the baseline of planned communication? |
| ii. | Is that unit of measurement valid given the tracking |
| | systems in place in the project environment? |
| iii. | Is that unit of measurement an accurate reflection of |
| | the target observable behavior you want to for your |
| | project environment? |

| 3. | Combine the baseline of planned communication and the baseline | |
|---|---|---|
| | of planned target observable behavior and outcome for your project | |
| | environment. (Extension: In the examples this has been done using | |
| | a two dimensional chart such as tracking the schedule of planned | |
| | communication against the schedule of planned task delivery. For | |
| | further study, a larger set of variables can be used, combined and | |
| | studied to develop multidimensional models linking communication | |
| | and project performance.) | |
| 4. | Track actual communication and actual achievement of target | |
| | observable behavior and desired outcomes. | |
| 5. | Analyze and interpret the actual data. | |
| | a. | Calculate the communication variance (COM V) between |
| | | actual communication (A COM) and planned communication |
| | | (P COM). |
| | b. | Calculate the variance of project environment performance |
| | | between planned observable behavior, including desired |
| | | outcomes, and actual observable behavior, including desired |
| | | outcomes. |
| | c. | Apply other analytic tools. |
| | d. | Interpret the variances and data. |
| | e. | Identify communication environment variables that can be |
| | | changed, if necessary, to enhance the likelihood that the |
| | | project environment exhibits the target observable behavior |
| | | and increase the likelihood of delivering desired outcomes. |

| | |
|---|---|
| 6. | Take management action, if necessary, by changing the relevant |
| | communication environment variables identified in the analysis and |
| | interpretation of the actual data. |
| 7. | Iterate the process of tracking, analyzing, interpreting and taking |
| | management action to help achieve the target observable behavior |
| | and desired outcomes. |
| 8. | Change the integrated communication strategy when necessary. |

### Example 3

TABLE 3 describes a sample embodiment. In this embodiment the number of emails has been selected to characterize the communication environment. The number of emails is the MCA. In this example, the number of emails generated by the process of distributing task information to team members is estimated for each week, for a project made up of one project manager, one team leader and five team members.

TABLE 3

| Steps in the Integrated Communication | | Number of | |
|---|---|---|---|
| Strategy | | Emails Generated | When |
| 1. | Updated tasks for a project are sent out | 1 | Week 1 |
| | by the project manager on the first | | |
| | Monday of the month to the team | | |
| | leader. | | |
| 2. | The team leader then distributes tasks | 5 | Week 1 |
| | out to the team members by Tuesday | | |
| | morning with each team member | | |
| | receiving one email to them that | | |
| | contains all task information. No-one | | |
| | else is cc'd or bcc'd on those emails. | | |
| 3. | Team members should use chat or ad- | 0 | Week 1 |
| | hoc conversations between themselves | | |
| | to get further clarification on the tasks. | | |
| | However, team members should not | | |
| | forward emails to each other with the | | |
| | task information and questions. | | |
| 4. | If questions still remain, team members | 0-5 | Week 1 |
| | must submit all questions by Friday | | |
| | morning; all questions must be in one | | |
| | email sent directly to the team leader | | |
| | without any cc's or bcc's. | | |
| 5. | The team leader must send out a | 0-5 | Week 2 |
| | single response to all questions by the | | |
| | following Thursday directly to the team | | |
| | member who asked it. If the team | | |
| | leader doesn't know the answer to the | | |
| | questions, the team leader should call | | |
| | the project manager on Tuesday for a | | |
| | detailed question and answer session | | |
| | conducted over the phone. | | |
| 6. | If team members still have questions, a | 0 | Week 2 |
| | meeting should take place on that | | |
| | Friday with the team members that | | |
| | have questions, the team leader and | | |
| | the project manager. No notes need to | | |
| | be generated from the meeting. The | | |
| | outcome is the project team having | | |
| | sufficient information to work on the | | |
| | tasks. | | |
| 7. | If there are questions the project | 0 | Week 2 |
| | manager can't answer, the task is | | |
| | pushed off for the following month's | | |
| | updated list while the project manager | | |
| | obtains the necessary information. | | |
| 8. | The team works on their tasks for the | 5 | Week 4 |
| | remainder of the month and report the | | |
| | status of their tasks at the end of the | | |
| | month with one email each directly to | | |
| | the team leader without any cc's or | | |
| | bcc's. | | |
| 9. | The team leader sends the project | 1 | Week 4 |
| | manager a single email updating the | | |
| | status of all tasks, without any cc's or | | |
| | bcc's. | | |

TABLE 4 summarizes the expected emails for each week. This is the Planned Communication (P COM).

TABLE 4

| | Expected | |
|---|---|---|
| Week | emails | Explanation |
| Week 1 | 11 emails | There is a possible 6-10 emails. But assuming |
| | | every team member has questions, estimate 10 |
| | | emails for week one. |
| Week 2 | 5 emails | The assumption is maintained that every team |
| | | member has questions and therefore the team |
| | | lead needs to send 5 emails in week 2. |
| Week 3 | 0 emails | Everyone is busy working. Ongoing |
| | | communication takes place using other methods. |
| Week 4 | 6 emails | Each of the five team members sends an update |
| | | to the team lead. The team lead sends one |
| | | update to the project manager. |

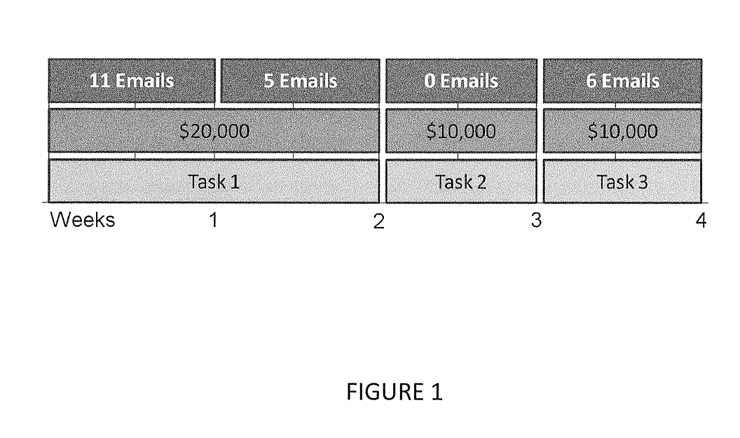

FIG. 1 shows the combination of Planned Communication with characteristics that have been selected to be desired for this sample project. Specifically, in this example the project is being managed to deliver on budget and on time. For this example the technique of Earned Value Management (EVM) is being used to facilitate management towards these goals. FIG. 1 shows the combination of P COM, the number of expected emails for each week, with a performance management baseline (PMB). For purposes of this example, it is assumed that estimated cost, schedule and planned value have already been determined.

TABLE 5 is an example of a chart showing P COM and actual communication (A COM) for three sample scenarios. P COM and A COM are shown as cumulative values. A COM comes from collecting data on actual communication.

TABLE 5

| | Scenario One | | Scenario Two | | Scenario Three | |
|---|---|---|---|---|---|---|
| Week | P COM | A COM | P COM | A COM | P COM | A COM |
| 1 | 11 | 11 | 11 | 11 | 11 | 11 |
| 2 | 16 | 16 | 16 | 11 | 16 | 11 |
| 3 | 16 | 16 | 16 | 11 | 16 | 16 |
| 4 | 22 | 22 | 22 | 17 | 22 | 22 |

Three sample scenarios are described in TABLE 5.

Scenario 1

The integrated baseline from FIG. 1 shows that at the end of two weeks it is expected to complete Task 1 and earn $20,000 worth of value. This is accomplished with 16 emails in the environment. Scenario 1 is where a status update is received that states Task 1 is not complete even at the end of week four and that 16 emails were in the environment during the first two weeks. Communication went as planned but the project is behind schedule.

Scenario 2

A status update is received that states Task 1 is not complete even at the end of week four and that 11 emails were in the environment during the first two weeks. Communication is less than planned and the project is behind schedule. Further analysis shows that 11 emails were in the environment in week one and 0 emails in week two.

Scenario 3

Scenario 3 is a derivation of scenario 2. However, it differs in that at the end of week three A COM was in line with P COM. Further analysis showed that there were 11 emails in week one, 0 emails in week two but 5 emails in week three.

Next, Communication Variance (COM V) is calculated. TABLE 6 shows Communication Variance (COM V) for the three scenarios for specific points in time. TABLE 6 is read as follows:

For the first scenario, at two week COM V=0. A COM=16. P COM=16. A COM−P COM=0.

For the second scenario, at two weeks COM V=−5. A COM=11. P COM=16. A COM−P COM=−5.

For the third scenario, at two weeks COM V=−5. A COM=11. P COM=16. A COM−P COM=−5

TABLE 6

| | Scenario One | Scenario Two | Scenario Three |
|---|---|---|---|
| Week | COM V | COM V | COM V |
| 1 | 0 | 0 | 0 |
| 2 | 0 | −5 | −5 |
| 3 | 0 | −5 | 0 |
| 4 | 0 | −5 | 0 |

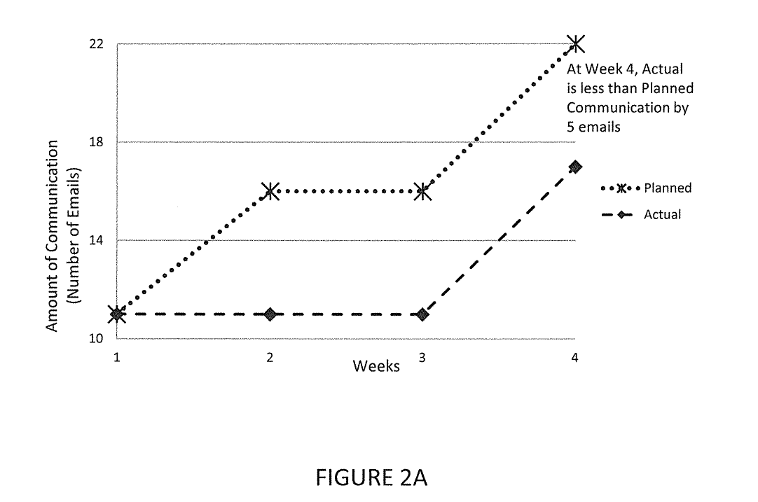

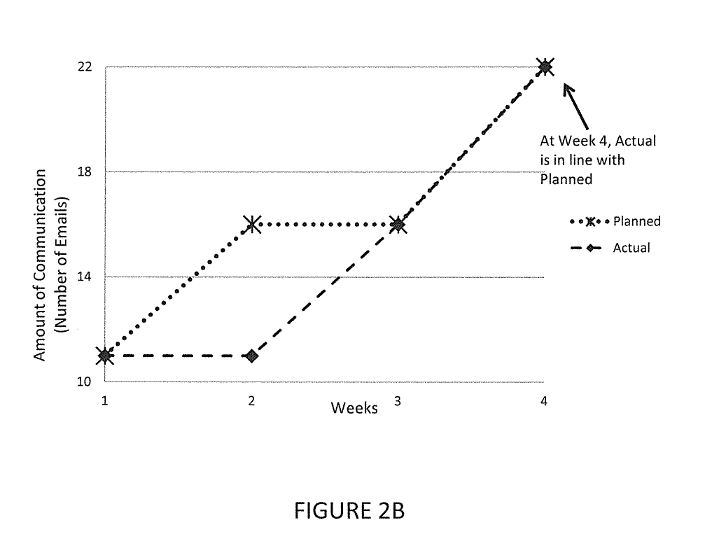

FIGS. 2A and 2B are graphs showing P COM and A COM for scenarios two and three, respectively.

### Example 4

### Case Study

Here is an example of what a communication object and object elements looks like on a live project. The example is pulled from a real life situation but has been modified due to confidentiality.

The IT department is part of a large, integrated project team. They are responsible for the maintenance and operations of the servers on the project. As part of their communication process, they utilize an integrated ticketing and issue management system. The integrated system sends out emails to the project manager whenever there is an update to the project manager's project servers.

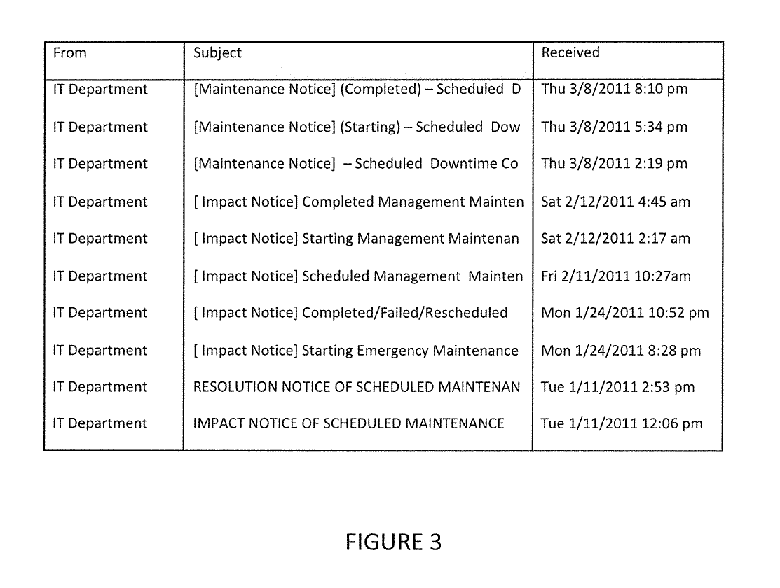

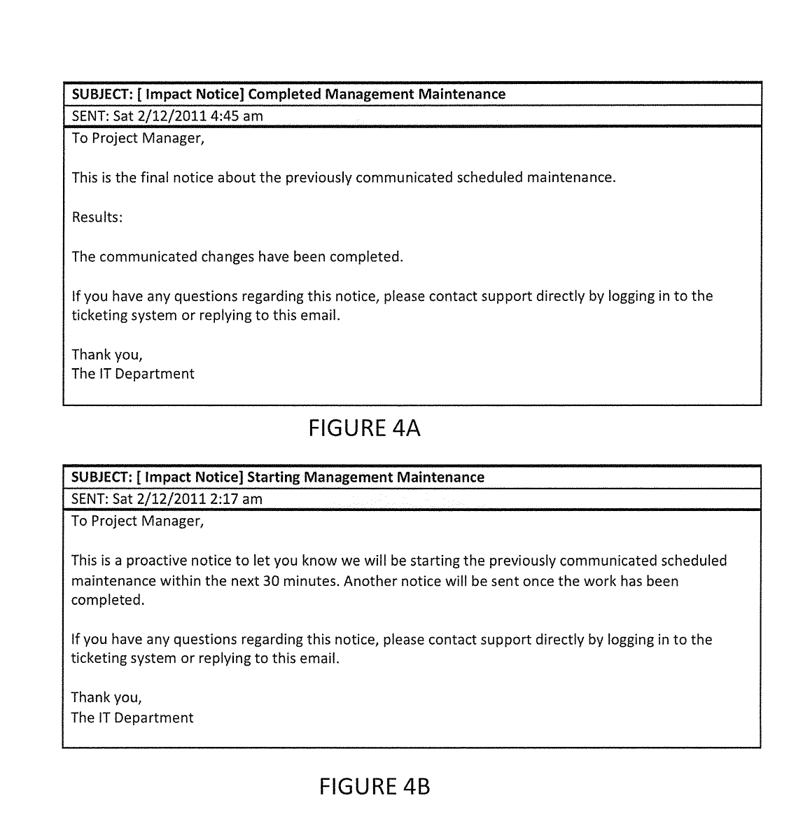

Since the IT department does a very good job in keeping the servers going, a vast majority of the emails sent to the project manager concern do not require any input from the project manager. For example, FIG. 3 is a mock-up of the project manager's inbox showing emails from the IT department over a three month period of time. The truncated subject line reflects the project manager's configuration of their inbox. FIGS. 4A and 4B are the text of a few of the usual emails.

As can be seen, the IT Department broadcasts about once or twice a month. It generally sends out three emails. One is to announce an upcoming action. One is to announce the beginning of the action. One is to announce the end of the action. The emails do not require any intervention by the project manager. The issues are announced and resolved by the IT department on their own. Over time, the project manager has come to simply delete emails from the IT department.

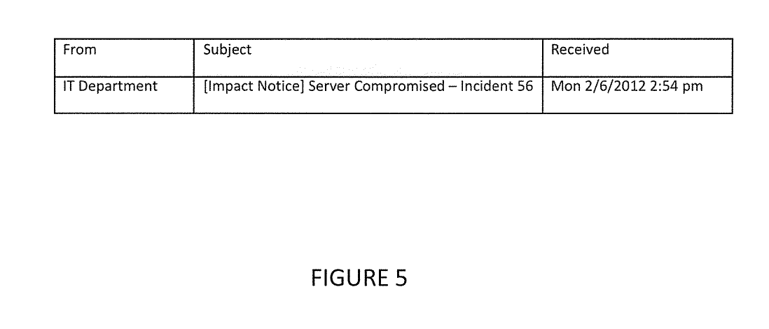

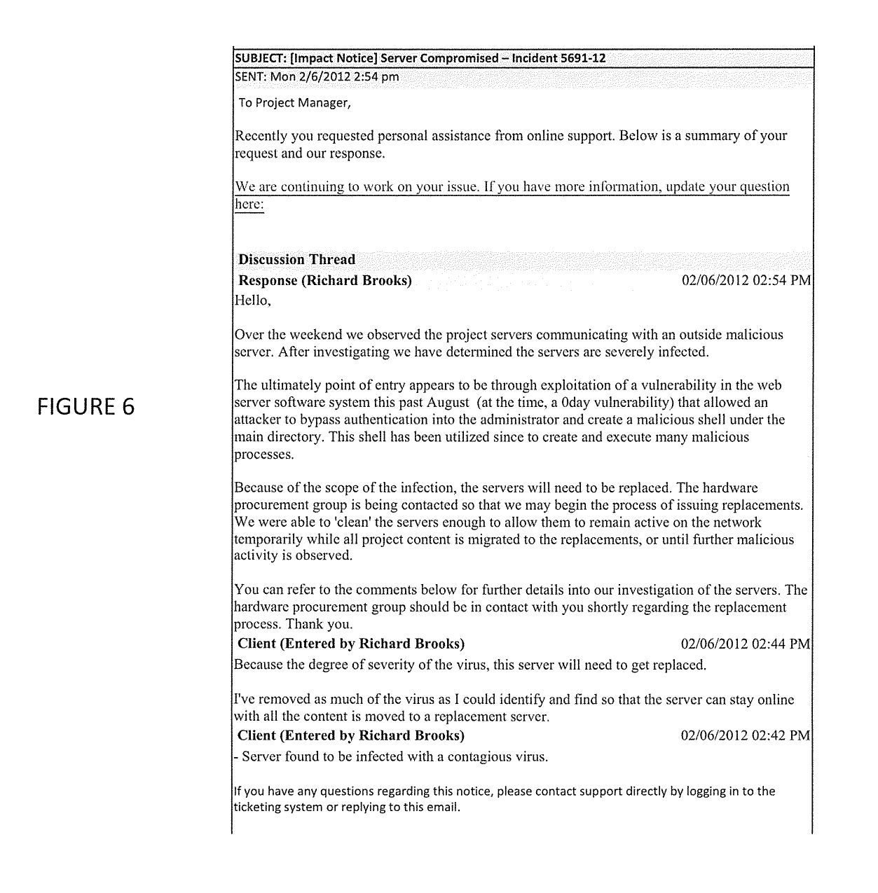

On a Monday, the project manager was traveling out of the office for project related business. She checked her inbox from her phone and noticed that there was an email from the IT Department (FIG. 5). The project manager would usually delete the email. But, the subject line looked different from the usual emails. The IT department had been known to change subject lines over time for no known reason to the project manager. But the project manager decided not to delete the email and to look at it later. She had a meeting to attend at the moment. Later in the evening, around 6:00 pm, she read the email. FIG. 6 shows what it said.

She came away with the impression that the IT department was doing their usual excellent job of keeping things going, that there were no risks to her project and that no input was needed from her. This impression was based on her past experiences with communication from the IT department as well as the following information gleaned from the content of the email.

The issue was detected over the weekend and she was not notified. Therefore, it must be low risk and manageable by the IT department.

The issue was detected over the weekend and the IT department was only getting to it now, on Monday afternoon. Therefore, it must be low risk and not very pressing.

The email thread stated that the IT department had already set a process in motion to get the replacement servers. Therefore, not action was needed on her part.

The email was said to be in response to a request made by the project team to online support. Yet the original entry was made by Richard Brooks, who is in the IT department and not part of her team. Therefore, the IT department was “faking” the interaction with the client in order to log the issue in the issue management system but no interaction was really necessary.

To confirm this last point, she called the lead on her task delivery team to ask if he or anyone from the team had contacted the IT department with an issue over the weekend or today. He checked around and got back to her that nobody had. This confirmed her impression that this was an internal

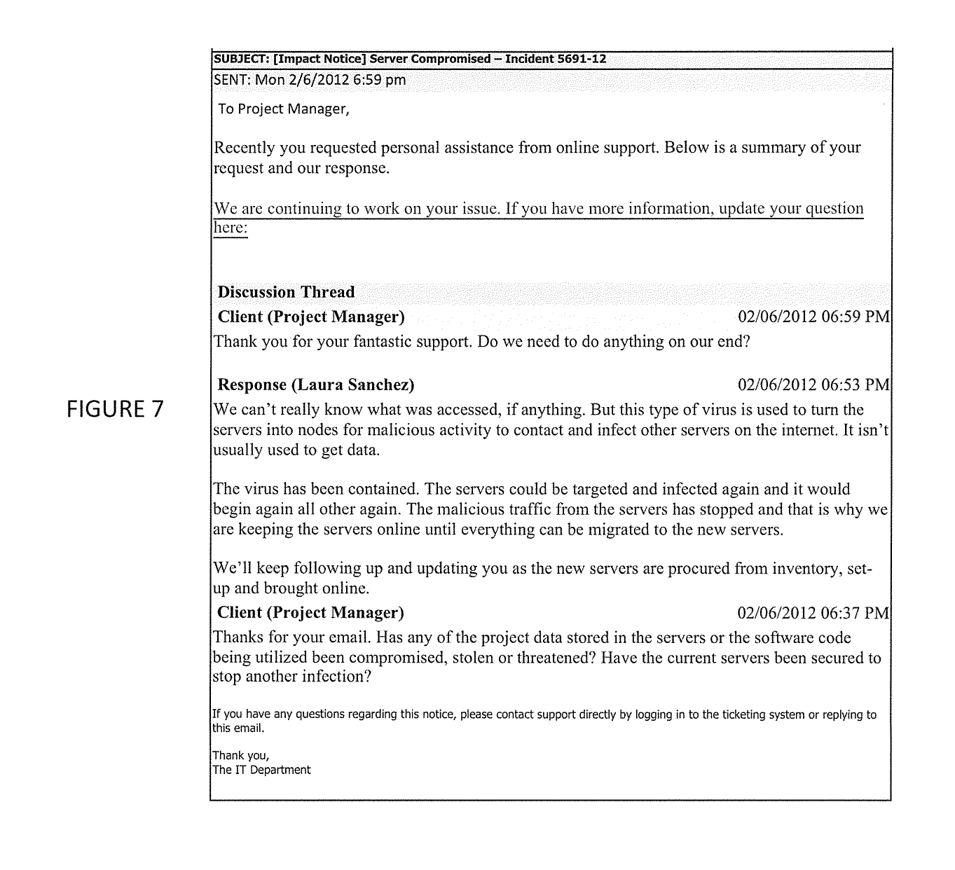

To be on the safe side she engaged in a conversation with the IT department. In the conversation she checked on the safety of the project data stored in the servers, got further confirmation of her impression that no action was needed on her part and thanked the IT department for always being on top of issues. FIG. 7 shows what the response thread looked like.

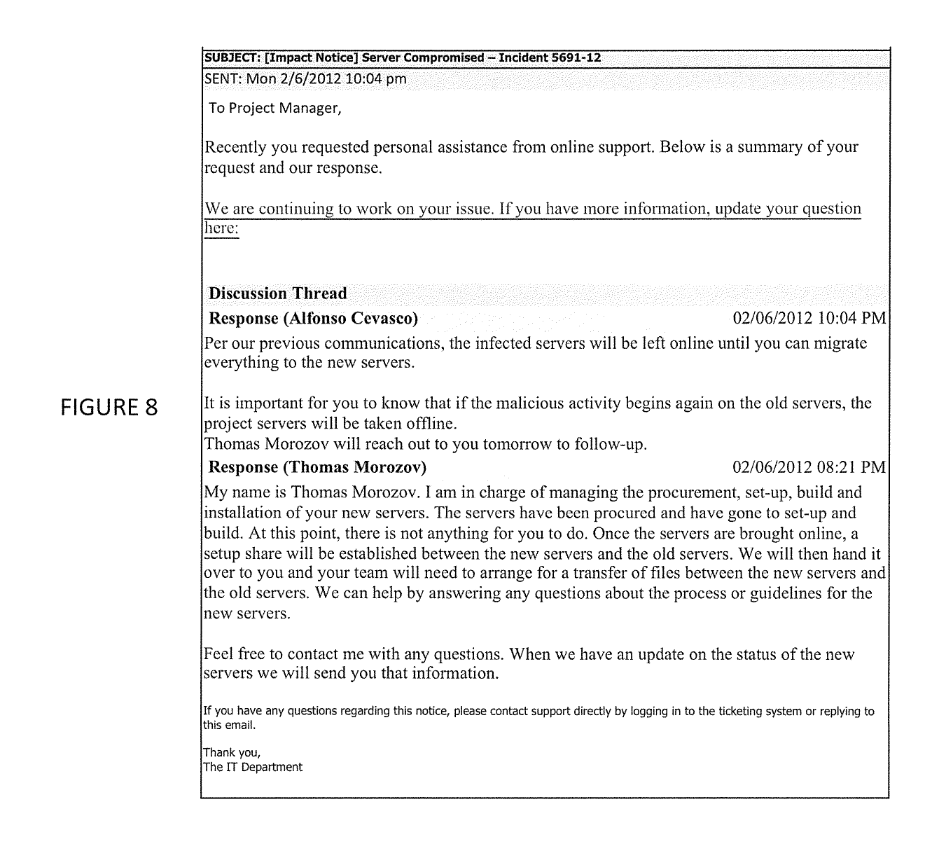

She didn't hear anything back from the IT department before her she had to leave at 7:30 pm for a dinner meeting. She figured that no news was good news and left confirmed in her understanding that the IT department had everything under control. She scanned an email that came in from the IT department around 8:30 pm. The IT department had moved quickly to get new servers procured from inventory and in the process of getting set-up. It mentioned some activity that her team would need to coordinate later. Everything continued to appear under control without risk to the project. When she returned to the hotel around 10:30 pm she checked her email and was shocked by what she read in FIG. 8.

The latest email said that the project servers could be taken offline at any point. This now became a major risk to the project. Needless to say, she was not happy to read that. Her risk management plan relied on the IT department being accountable for server related risks. She listed potential impacts on her end, determined what information would be helpful for her to obtain and called the IT department to get further information. Most importantly, she wanted to understand the probability that the servers would be taken offline and what mitigation efforts could be put in place.

When she called, she got the night crew. After a frustrating 15 minute conversation it was clear that the night crew and her were speaking different languages. They were not able to give her a probability or to understand why it would be necessary to have one. They were focused on a conveying the messages that they had no way of knowing if and when malicious activity could start again, that the servers could be taken offline at any point and, that she should call Thomas Morozov tomorrow to follow-up on the migration plan. They had no way of contacting him this evening.

She did not make any headway on the probability or mitigation efforts. She was able to get them to agree to notify her, via a phone call, before the servers would be taken offline, no matter what time of day or night.

She hung-up with the night crew and begrudgingly called her team lead. It was now 11:15 pm. She apologized for calling him so late. She let him know that the servers could be taken offline at any point in time and there was no mitigation plan. She asked him to check on the status of the offsite server back-ups which she had procured, independent of the IT department. The team leader confirmed that the back-ups were running smoothly, were up-to-date and were available for a restore onto new machines should the project servers go down. That was a relief to her and a testament to her planning. Worse comes to worse, if the servers were taken offline her team and customers would lose some time but they would not lose data. She told him that no further action was needed right now and asked him to be ready to send out a message to the project team if she got the call that the servers were being taken offline. He agreed. She planned the calls she would need to make to the stakeholders and project customers, if the servers were taken offline. She prepared to cancel all her scheduled appointments for the next day. She did not sleep much that night.

As the hours passed, the servers remained online.

Early in the morning, she fired-off an email to the most senior person she knew at the IT department. She asked for a call as early as possible. He called her right away. Together, on the phone, they reviewed the situation. He was able to tell her that the probability of the servers being taken offline was very, very low. The original engineer who cleaned the servers had done an excellent job. He got Thomas Morozov on the line to get a sense of the schedule for having the new servers up and ready. Together they mapped out a target timeline for the migration and the steps that would need to be taken. By the end of the call it became clear that there was no urgency in doing the migration. A risk remained but it was being managed.

She got off the call and called the team leader. She updated him on the situation. They put together a plan for the migration with clear next steps. She thanked him for being available last night. She went to her appointments that day as scheduled. To complete the story, the servers remained online without a problem for another five weeks until the migration was completed.

Long Term Impact

The incident had a long term impact on the project manager and her team. Most directly, it reduced her trust in the IT department. One sleepless night can do that. Consequently, she began looking at outside providers who she could directly communicate with to meet the needs which the IT department provided.

The incident also directly affected her team's solution delivery capabilities. It reinforced her perception of the IT department as a service bureau. She was not alone in this perception. All the project managers shared this perception and it affected the solution delivery capabilities of project teams throughout the organization.

The IT department was designed and set-up like a utility to provide a needed service for projects. It focused on provider hardware, networking and connectivity. It was not, and could not be, an integrated part of a project team. As a result, project managers never considered hardware, connectivity or networking as areas that could contribute to an innovative solution. They were simply necessary components of a project, like having lights and electricity. They would no more call IT and ask for their input on a potential project than they would call up the electricity company. The areas that the IT department focused on were not value-added areas for innovative solutions.

Project managers in the organization focused on software and process improvements to deliver solutions. They never would think of providing an integrated hardware and software solution that leveraged embedded circuits or hardware optimized for a specific purpose. Hardware, connectivity and networking were simply a layer that solutions had to sit on. Because of this, project managers began looking more at cloud based solutions for meeting project needs. After all, if someone outside the organization could provide the same utility at a lower price, with better responsiveness, it would benefit the organization's bottom line. The IT department's focus on being an efficient service bureau paved the road for their own irrelevance.

Further, by looking at software only solutions, the organization missed out solutions that potentially offered higher margins and a more competitive position in the market. Integrated hardware and software solutions can be faster and more efficient than a software only solution, making them more attractive for specific uses by customers. Because they contain hardware, they can leverage economies of scale from industrial production. Integrated solutions offer a more defensible market position since they can provide a greater barrier to entry against competition compared to software only products, which are more highly portable. By operating the IT department as an efficient service bureau, the organization missed out on these benefits.

Analysis Using Communication as a Performance Management Tool

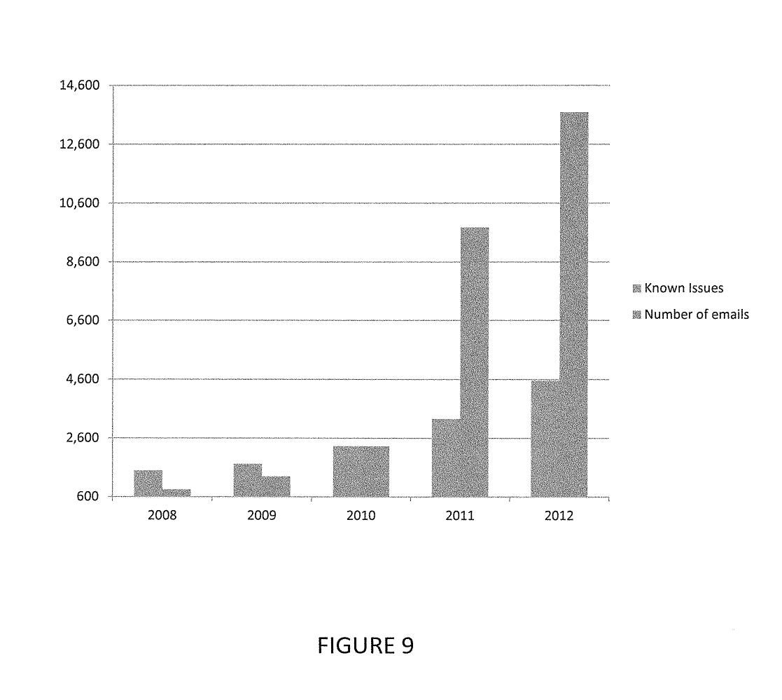

The impact of the organization's communication environment on its solution delivery capabilities can be analyzed using the communication object elements. The goal of the current communication environment is to broadcast out information about known issues which can affect a client's projects. Since the IT department uses an automated ticket and issue management system which generates emails, we can study the emails generated. A good analytic tool to measure the effectiveness of the goal would be to compare the number of known issues against the number of emails sent about the issue. An example of fictional data for this measurement is displayed in FIG. 9.

This first thing learned from the data in FIG. 9 is the growth in the number of known issues. This is a result of the growth of the organization and increase use of the IT department's services as the organization has grown. Known issues grew from 1,500 in 2008 to nearly 4,600 in 2012.

The evolution of the communication system over this period of time is also seen. In 2008, there were 800 emails sent out for the 1,500 known issues. Emails were sent in 57% of the time. Information was falling through the cracks and people were being caught off guard. Even if most of the issues didn't affect project managers, all it takes is one big mishap that could have been prevented with advance warning, to kick-off a corporate wide initiative to change the system. In 2009, roughly 1,300 emails were sent out covering 75% of the 1,725 issues during the year. In 2010, every single known issue was covered in an email. There were 2,329 issues and 2,329 emails. These were advance notifications before the issue was going to occur.

However, leadership determined that that was not sufficient information. They implemented a program to send out advance notification, notification of when the issue was starting and notification of when the issue was resolved. This resulted in three emails being sent for each known issue. Because the system of matching emails to issues had been perfected in 2010, it was relatively easy for the IT department to scale from 1:1 to 3:1. As is seen from FIG. 9, in 2011 and 2012 there were three emails for every one known issue. This resulted in 9,781 emails in 2011 for the 3,260 known issues and nearly 13,700 issues in 2012 for the 4,564 known issues.

The program of having three emails for every known issue did a good job in broadcasting out information. Never again could anyone say that they were not sufficiently apprised of known issues and their potential impact on their project servers. While a success for the goal of broadcasting information it created a massive influx of communication to project managers, most of it irrelevant. It resulted in a system where as the organization grew and the need for the IT department's services grew, the amount of communication from the department increased three fold. Thus, despite the growing importance of the IT department as a service provider, communications from the IT department were being increasingly ignored.

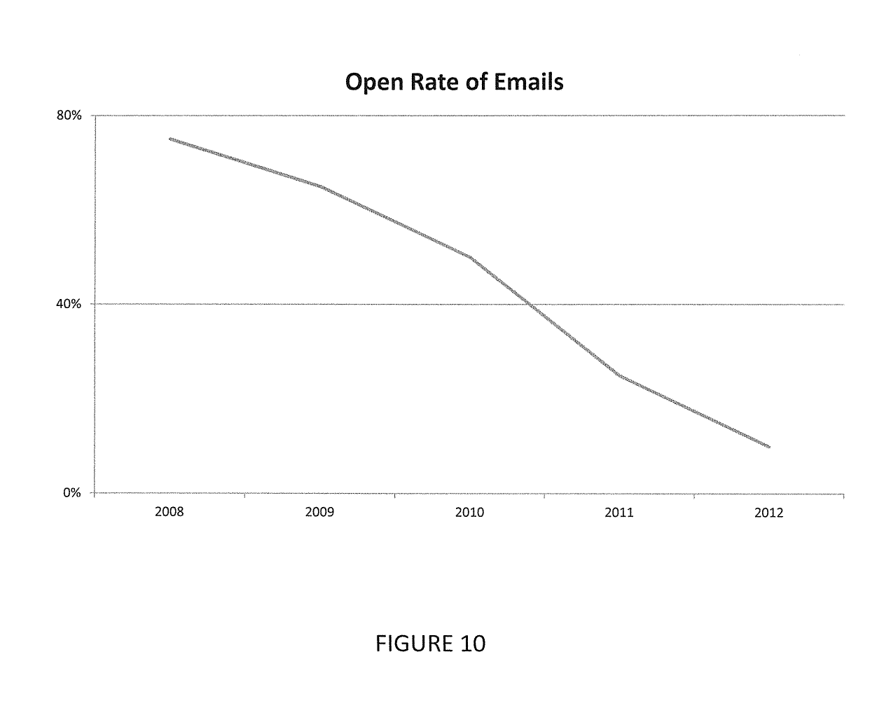

That can be seen by looking at the open rates for emails from the IT department over time. An example of fictional data for this estimated trend is shown in FIG. 10.

This data shows that as the number of emails from the IT department increased, fewer and fewer of them were being opened. This is a testament to the consistent performance of the IT department as a service bureau. They were taking care of business, keeping everything running and under control without catching anyone's attention. They had successfully made the IT department a seamless utility for the organization.

Being successful in this goal, however, had an impact. The communication environment was meeting its goal of notifying project managers but was failing in other ways. Consider the need to have the IT department be a trusted part of a project team, a team player with whom other team members communicated, rather than being a service provider. Were the goal to have IT be an integrated part of a project team, one could still use the same communication object of the emails from the automated ticket and issue tracking system. But one would apply a different analytic tool. One would look at the reply rate of each email. Each email solicits interaction from the recipient. It allows a recipient to engage in a conversation with the IT department by logging in to the ticket system or by replying directly to the email just as one would with any email sent from a person.

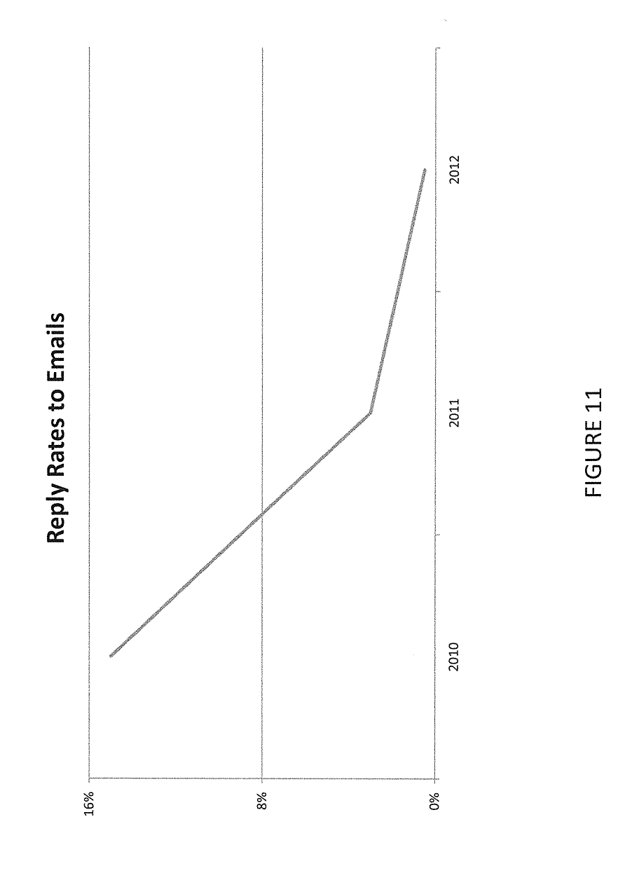

It can be seen that by looking at the reply rates for emails from the IT department over time. An example of fictional data for this estimated trend is shown in FIG. 11. The data starts in 2010, which is when the current automated system was implemented.

Here the consequences of the communication environment is seen. The significant increase in the number of emails and the fall in open rates translates directly into a near zero level of interaction between project team members and the IT department. A project team member would only reply to the IT department if something were wrong. Any interaction with the IT department is biased towards negative risk from the outset. It doesn't take long for an interaction with the IT department to reinforce the image that the IT department is filled with tech geeks who provide little value to projects and who could not contribute to innovative solutions.

The IT department has been successfully placed in a silo and cut off from being an integrated member of project teams. This directly impacts the organization's solution delivery capabilities. This can be predicted using an analysis of the emails as communication objects and applying the analytic tool that best matches the desired goals of the project environment. In this way, communication can be used as a performance management tool. The next step to improving the performance of the project environment is to vary communication object elements, such as number of emails per known issue, frequency of communication, target recipient or contents of the email, and measure the changes against the analytic tool. For example, in the case study above seeing how a change in the frequency of emails sent to the project manager changes the response rates of those emails.

Throughout this application, various publications are referenced by author and year. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A method of improving project outcome, including the steps of:
using communication to assess a project; and
improving the project outcome.

2. The method of claim 1, wherein said using step is further defined as establishing a baseline of planned communication decisions, measuring actual communication, calculating a variance in communication, and using the variance to modify future planned communication decisions.

3. The method of claim 1, wherein said improving step occurs in real-time.

4. A method of evaluating project performance based on the communication environment and communication objects used, including the steps of:
identifying the desired characteristics of the project;
selecting characterizations of the communication environment and communication objects to be Measurable Communication Actions (MCAs);
establishing a baseline of planned communication (P COM);
taking measurements throughout the course of the project to assess actual values for the MCAs and obtaining Actual Communication (A COM);
comparing the A COM against the P COM and deriving a communication variance (COM V); and
analyzing and tracking COM V against the desired characteristics of the project.

5. The method of claim 4, wherein said identifying step is further defined as identifying desired characteristics chosen from the group consisting of the communication tools or methods used in an environment, rules or guidelines on using communication tools or methods, how task assignments are made, how teams are organized, where personnel are located, the amount of oversight required, rules and guidelines on project governance, how tasks are described, when communication takes place, what types of documents are generated, who can talk to whom on a project, work breakdown structures (WBS), a WBS dictionary, Integrated Master Plans (IMP), organizational breakdown structure (OBS), emails, phone calls, phone messages, reports, chat messages, texts, attachments in emails, documents, message board posts, meeting notes, meetings, risk registers, responsibility assignment matrices, a project schedule, a project budget, compliance regulations, compliance filings, regulatory filings, guidelines, memos, and combinations thereof.

6. The method of claim 4, wherein said selecting step is further defined as selecting measurable aspects of the desired characteristics.

7. The method of claim 4, wherein the MCAs are chosen from the group consisting of semantic analysis, social network analysis, LWIC analysis, number of communications sent, semantic analysis of the content of the communications, use as a boundary object, assessments of cultural characteristics, tone of the communication object, relationship of the sender and receiver, whether an attachment in an email is opened, similarity of format of the documents that a sender and receiver send in emails in format, and combinations thereof.

8. The method of claim 4, wherein the P COM is the expected number of MCAs for a period of time.

9. The method of claim 4, wherein the period of time is chosen from the group consisting of hours, days, weeks, months, years, coincident with phases or events within a project, and combinations thereof.

10. The method of claim 4, wherein said taking measurements step is further defined as taking measurements at a time chosen from the group consisting of real-time, every hour, every day, every week, every month, every year, after an occurrence of a communication event, coincident with phases or events within a project, and combinations thereof.

11. The method of claim 4, wherein said method is performed in real-time.

12. The method of claim 4, further including the step of changing a variable chosen from the group consisting of P COM values, communication object elements, communication environment elements, and combinations thereof based on the COM V derived.

13. The method of claim 4, further including the step of causing an alert based on an undesired COM V value of the potential of project failure.

14. The method of claim 13, wherein the alert is chosen from the group consisting of and email, text message, phone message, visual alert, noise, flagging COM V outside of desired threshold range, or combinations thereof.

15. The method of claim 13, further including the step of changing a variable chosen from the group consisting of P COM values, communication object elements, communication environment elements, and combinations thereof in response to the alert.

16. The method of claim 4, further including the step of measuring an outcome chosen from the group consisting of profitability, number of innovations, number of patents, market position, riskiness, number of participants, contribution of participants, outcome at a trial, trust within a group, knowledge sharing, knowledge creation, knowledge development, leadership ability, proficiency in a desired competency or competencies, technical readiness level, fitness for a specific purpose, marketability, revenue, cost to produce innovation, cost to deliver desired capabilities, the amount of time it takes to deliver desired capabilities, return on investment, return on capital, stock market performance, and combinations thereof.

17. The method of claim 4, wherein said steps are encoded as software on a computer readable medium.

18. The method of claim 17, wherein the software is chosen from the group consisting of an application that plugs into existing platforms and an integrated tool set.

19. The method of claim 17, wherein A COMs and P COMs are obtained by a project participant, sent to a central server, V COMs are calculated and sent back to the project participant.

20. The method of claim 17, wherein the software is programmed on a computing mechanism chosen from the group consisting of a handheld tablet, mobile computing device, and a cloud.

21. The method of claim 18, wherein the integrated tool set includes objects to be analyzed, analytic processes that generate object elements, and measures of desired project characteristics, and allows for the development of the P COM, A COM, and COM V and an analysis of these items against the project's performance relative to desired project characteristics.

22. The method of claim 4, further including the step of during performance of a project, performing an action chosen from the group consisting of enforcing, suggesting, or auto-correcting communication decisions.

23. The method of claim 4, further including the steps of creating communication guidelines for a business, creating an assessment tool that assesses the fitness of a communication environment or communication objects for meeting specific project outcomes, providing certification of communication to businesses, and combinations thereof.

24. The method of claim 4, wherein the project is chosen from the group consisting of training programs, communications with jurors, leadership development programs, acquisition programs, research, development and technology evaluation programs, and knowledge creation, knowledge discovery, and knowledge sharing programs.
